(19) United States
(12) Patent Application Publication
(10) Pub. No.: US 2026/0116574 A1
(43) Pub. Date: Apr. 30, 2026

(54) MAGNETIC ATTACHMENTS AND PROTECTIVE BARRIERS AND COVERINGS FOR VEHICLES EMPLOYING THE SAME

(71) Applicant: Kennon Products, Inc, Sheridan, WY (US)

(72) Inventors: Cameron Ellis, Sheridan, WY (US); Nate Williams, Sheridan, WY (US); David Eugene Klug, Sheridan, WY (US); Dakotah Gali, Sheridan, WY (US); Katherine Emond, Malta, MT (US)

(21) Appl. No.: 19/042,940

(22) Filed: Jan. 31, 2025

Related U.S. Application Data
(60) Provisional application No. 63/548,749, filed on Feb. 1, 2024.
(60) Provisional application No. 63/552,114, filed on Feb. 10, 2024.
(60) Provisional application No. 63/682,442, filed on Aug. 13, 2024.

(51) Int. Cl. B64F 1/00

(52) U.S. Cl. CPC B64F 1/005

(57) ABSTRACT

A magnetic attachment for aircraft equipment may attach directly to a surface of an aircraft by targeting ferrous aircraft components within or on the aircraft. The attachment does not rely on straps, buckles, hooks, cords, ropes, pins, or the like. A removable protective barrier for at least one aircraft critical area may include a polymeric body capable of conforming to curvature and geometry of the at least one aircraft critical area; and a magnetic attachment to secure the polymeric body to an aircraft. A conformable covering for an aircraft transparency may include one or more elastomeric materials assembled and temporarily installed on at least one external surface of the aircraft transparency to create a barrier between the aircraft transparency and an external environment, wherein the assembly may be capable of conforming to doubly curved surfaces; and a magnetic attachment capable of securing the assembly to an aircraft.

### CROSS-REFERENCE TO RELATED APPLICATIONS

The present application is a non-provisional of, and claims priority to, U.S. Patent Application No. 63/548,749 filed Feb. 1, 2024, U.S. Patent Application No. 63/552,114 filed Feb. 10, 2024, and U.S. Patent Application No. 63/682,442 filed Aug. 13, 2024, the disclosures of which are incorporated by reference in their entireties.

### FIELD OF THE DISCLOSURE

The present disclosure generally relates to affixing equipment to stationary vehicles, such as aircraft, with magnetic attachments, and preventing foreign objects from entering critical areas during maintenance and/or storage. It also relates to conformable coverings, such as for aircraft canopies and other transparencies.

### BACKGROUND

Equipment sometimes needs to be attached to stationary aircraft. Often, equipment is attached using straps, buckles, hooks, cords, ropes, pins, or the like, or relies on aircraft geometry to create an interference fit between the equipment and the aircraft. These attachment mechanisms, however, are limited to use with durable attachment points that can securely hold or receive the attachment device, such as a hook or pin, and modern aircraft are increasingly designed with smooth, convex geometry, lacking durable attachment points and thus limiting the efficacy of extant attachment mechanisms.

Further, existing attachment mechanisms typically require contact between the attachment mechanism and the aircraft and between the equipment and the aircraft. This contact may result in accelerated wear of the aircraft coating, paint, or external surface, which in turn degrades the performance of the aircraft and results in an unnecessary maintenance burden on aircraft operators.

In addition, various critical areas on modern aircraft need to be protected from foreign objects during common maintenance and sustainment tasks. While technologies such as textile-wrapped or coated foam plugs may protect aircraft engine inlet and exhaust ducts from foreign objects, other critical areas upon or in an aircraft are susceptible to foreign agents during maintenance and sustainment tasks, but often lack dedicated protection. These other critical areas include lights, lenses, sensors, flush-mounted vent screens, inlet vents, exhaust vents, air vents, cooling vent screens, auxiliary air control inlets, ducts, vents, or passages, panel seams, aerial refueling access panels, panel seams, and fuel or chemical dump outlets.

In the absence of dedicated technology, protection has been achieved through temporary, field-expedient, and/or manually assembled methods such as single-use adhesive tape, coated or laminated papers, sheets of adhesive-backed plastics, plastic bags or sheeting, or the like, which significantly increases the time and labor required to conduct basic procedures and tasks. There also may be significant human factors risk which heavily relies on attention to detail and proper training to avoid imparting undesirable effects, adhesives, or materials to the aircraft in an attempt to protect its critical areas.

Further, while there are various means to cover and protect aircraft transparencies, they have several disadvantages. The materials used to construct traditional transparency coverings lack the ability to conform to complex surfaces (such as doubly curved surfaces), and instead rely on seams, darts, or other adjustment techniques to approximate the curvature of the transparency. The curvature-approximation techniques required to use non-conformable covering materials inherently results in gaps, folds, turns, or the like in the protective covering. These gaps, folds, turns, or the like can prevent the covering from sealing the perimeter of the cover from environmental conditions, such as wind entrapment, insects, sand intrusion, or the like. Incomplete perimeter sealing of the covering can result in damage to the transparency through abrasion from direct wind buffeting, trapping sand or other environmental contaminants against the protected transparency which can also abrade the transparency, or permitting liquids, chemicals, or the like to become trapped between the protective covering and the transparency which can cause damage.

### SUMMARY

Embodiments of the present disclosure provide a magnetic attachment for aircraft equipment capable of attaching directly to a surface of an aircraft by targeting ferrous aircraft components within or on the aircraft. The magnetic attachment may include one or more magnets, wherein each of the one or more magnets may have one or more permanent magnetic poles per attachment face. The magnetic attachment also may include one or more ferrous shunts each secured to an opposing face of the attachment face of each of the one or more magnets to form a magnet shunt assembly. The magnetic attachment may further include at least one encapsulating mechanism capable of encapsulating each magnet shunt assembly individually, wherein the magnet shunt assemblies form an array. The at least one encapsulating mechanism may include a first textile and a second textile, wherein the textiles are capable of being welded, sewed, adhered, or otherwise bonded to each other. The textiles may be non-elastic woven or non-woven textiles. Alternatively, the at least one encapsulating mechanism may be a polymeric matrix at least partially encapsulating each individual magnet shunt assembly. The magnet attachment also may include a non-slip material attached to at least one edge of the at least one encapsulating mechanism to provide an interface between the array and the aircraft. Each of the one or more magnets may have a thickness of at least 1/16″. The one or more ferrous shunts may be ferrous material having a thickness of at least 20% of the thickness of one of the one or more magnets with perimeter dimensions at least 75% but not more than 125% that of the magnet. The one or more ferrous shunts increase an attachment strength of each of the one or more magnets by at least 10%. The one or more magnets may be four distinct magnets.

Additional embodiments of the present disclosure provide a removable protective barrier for at least one aircraft critical area, the removable protective barrier comprising a polymeric body attachable to the at least one aircraft critical area, the polymeric body capable of conforming to curvature and geometry of the at least one aircraft critical area and surrounding surfaces; and a magnetic attachment arranged in a perimeter array to secure the polymeric body to an aircraft. The barrier also may include a seal around a perimeter of the removable protective barrier, the seal capable of isolating the at least one aircraft critical area. The seal may be secured to the aircraft with the magnetic attachment. The barrier also may include a removal handle. The barrier may further include an internal concentric gasket; a center concentric gasket; and an outer concentric gasket, wherein each of the internal concentric gasket, the center concentric gasket, and the outer concentric gasket may be located on an internal surface of the removable protective barrier. The barrier may have a geometric offset region capable of accommodating a lens, a sensor, a light, and/or another transparency. An exterior surface of the removable protective barrier may have a convex offset region, and the interior surface of the removable protective barrier may have a concave offset region.

Other embodiments of the present disclosure provide a conformable covering for an aircraft transparency comprising: one or more elastomeric materials assembled and temporarily installed on at least one external surface of the aircraft transparency to create a barrier between the aircraft transparency and an external environment, wherein the assembly may be capable of conforming to doubly curved surfaces; and a magnetic attachment capable of securing the assembly to an aircraft around an entirety of a covering perimeter. The aircraft transparency may be selected from an aircraft windshield, canopy, window, lens, or another aircraft component constructed of transparent materials. The covering also may include a continuous seal capable of isolating the aircraft transparency from environmental conditions when the conformable covering is installed. The magnetic attachment may be oriented as to an interfacial surface to contact a surface of the aircraft when installed on the aircraft transparency.

### BRIEF DESCRIPTION OF THE DRAWINGS

For a more complete understanding of this disclosure, reference is now made to the following description, taken in conjunction with the accompanying drawings, in which:

FIG. 01 depicts an exploded view of an encapsulated magnet shunt assembly in a textile according to an embodiment of the present disclosure;

FIG. 02 depicts a section view of encapsulated magnet shunt assembly in a textile according to an embodiment of the present disclosure;

FIG. 03 depicts an encapsulated magnet shunt assembly in a textile according to an embodiment of the present disclosure;

FIG. 04 depicts an encapsulated magnet shunt assembly in a polymeric matrix according to an embodiment of the present disclosure;

FIG. 05 depicts an exploded view of embedded or encapsulated magnet shunt assembly in a polymeric matrix according to an embodiment of the present disclosure;

FIG. 06 depicts an embedded or encapsulated magnet shunt assembly in a polymeric matrix according to an embodiment of the present disclosure;

FIG. 07 depicts a section view drawing of encapsulated and embedded magnet shunt assemblies in a polymeric matrix according to an embodiment of the present disclosure;

FIG. 08 depicts a protective barrier removably installed on an aircraft critical area according to an embodiment of the present disclosure;

FIG. 09 depicts an example of an aircraft critical area according to an embodiment of the present disclosure;

FIG. 10 depicts the interior and exterior of a representative protective barrier as constructed according to an embodiment of the present disclosure;

FIG. 11 depicts a section view of a representative protective barrier according to an embodiment of the present disclosure;

FIG. 12 depicts a section view of a magnetic attachment mechanism as located within the assembly of a protective barrier according to an embodiment of the present disclosure;

FIG. 13 depicts an example of a protective barrier with a geometric offset to accommodate a lens, light, or other transparency, removably installed on an aircraft critical area according to an embodiment of the present disclosure;

FIG. 14 depicts the interior and exterior of a representative protective barrier with a physical offset from a critical lens, sensor, or light surface according to an embodiment of the present disclosure;

FIG. 15 depicts a section view of a physical offset from a critical lens, sensor, and light surface according to an embodiment of the present disclosure;

FIG. 16 depicts a conformable covering installed on a representative aircraft transparency according to an embodiment of the present disclosure;

FIG. 17 depicts a representative, uncovered aircraft transparency demonstrating the doubly curved nature of modern aircraft transparencies, according to an embodiment of the present disclosure;

FIG. 18 depicts the conformable covering edge attachment assembly's interfacial surface between the covering and the aircraft according to an embodiment of the present disclosure; and

FIG. 19 depicts an exploded drawing of the edge attachment assembly according to an embodiment of the present disclosure.

### DETAILED DESCRIPTION

Embodiments of the present disclosure may provide a magnetic attachment which may secure equipment to stationary vehicles. For purposes of illustration, aspects of the disclosure will be described with reference to attaching equipment to stationary aircraft. Those of ordinary skill in the art will appreciate, however, that the teachings herein may be applied to good advantage in other contexts, and the description of aircraft herein should be regarded as exemplary rather than limiting.

As discussed herein, “magnet attachment” may refer to a distinct magnet having a thickness of at least about 1/16″ and at least one or more permanent magnetic poles per magnet attachment face. “Magnet attachment face” as described herein may refer to the external surface of a distinct magnet which is intended to attach, retain, and secure the magnetic attachment according to an embodiment of the present disclosure to a ferrous aircraft component (e.g., the aircraft-facing side of the magnet attachment). Ferrous targets or aircraft components may include, but are not limited to, coatings, adhesives, structural members, and/or non-structural members. These attachments do not rely on straps, buckles, hooks, cords, ropes, pins, or the like. Rather, one or more magnets may be positioned at key locations within a piece of equipment to attach the equipment directly to the surface of the aircraft by attaching to ferrous targets within or on the aircraft.

The magnetic attachment according to embodiments of the present disclosure may include one or more distinct magnets with a ferrous material attached as a shunt on the magnet face opposing the magnet attachment face. The ferrous shunting material may reduce unwanted magnetic field interaction and amplify the ability of the magnetic attachment to secure and retain a piece of equipment at its desired location. “Ferrous shunt” as described herein may refer to a ferrous material having a thickness of at least about 20% of the thickness of a distinct attachment magnet with perimeter dimensions at least about 75% but not more than about 125% that of the distinct attachment magnet.

“Magnet shunt assembly” as described herein may refer to a distinct attachment magnet with a distinct ferrous shunt durably attached to the magnet face opposing the desired attachment face of the magnet (e.g., opposite the aircraft-facing side of the magnet attachment). The body of the magnetic attachment being formed by one or more magnet shunt pairs (which may be referred to herein individually as a “magnet shunt assembly” and collectively as “magnet shunt assemblies”) may be durably encapsulated within a woven or non-woven textile in an array which may be capable of being welded, bonded, or otherwise secured to a material of the same or similar type, secured along at least one edge to an external coated or uncoated textile which may have non-slip properties and may serve as the interface material between the encapsulated magnet shunt assembly and the external environment or aircraft surface. Alternatively, the body of the magnetic attachment being formed by one or more magnet shunt assemblies may be durably embedded, suspended, or encapsulated by a polymeric matrix in an array which may be configured to secure, position, and retain the magnet shunt assembly and interface directly with the external environment or aircraft surface. This encapsulation may prolong the life of the one or more magnetic attachments, further amplify the ability of the magnetic attachment(s) to resist unwanted movement, protect magnets from damage, and/or prevent magnets from escaping the completed construction.

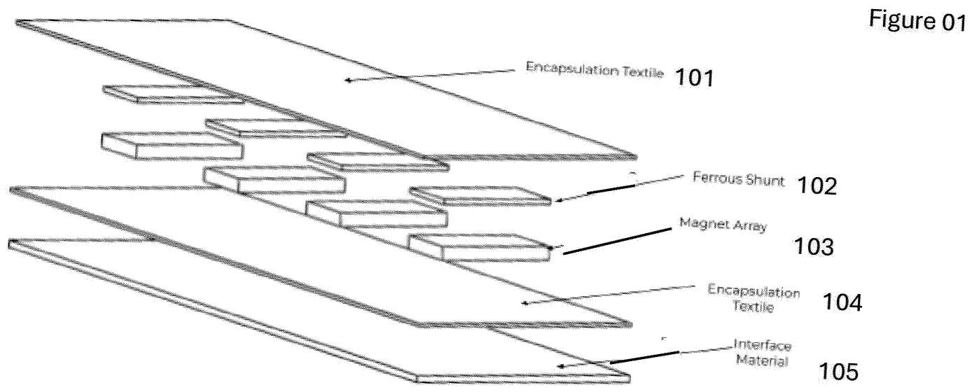

FIG. 01 depicts an exploded view of an encapsulated magnet shunt assembly in a textile according to an embodiment of the present disclosure. As depicted herein, multiple magnet shunt assemblies may be arranged in a linear array. An encapsulation textile (101) may be a non-elastic woven or non-woven textile coated on at least one side with a thermoplastic coating to permit thermal, ultrasonic, radiofrequency, or other plastic welding techniques to be used to bond the textile to itself or to a similar material, to completely encapsulate each attachment magnet shunt assembly when welded, bonded, or otherwise joined to a material of the same or similar type.

A ferrous shunt (102) may be durably attached to each distinct attachment magnet on the magnet face opposing the magnet attachment face. The ferrous shunt (102) may completely cover the opposing magnet face of each magnet and may redirect the magnetic field from the opposing face of each distinct magnet and increase the attachment strength of each distinct magnet by at least 10% in embodiments of the present disclosure. Ferrous shunt (102) also may limit undesirable magnetic interaction between other magnets within an array. This may increase ease-of-use during installation, removal, and/or storage and/or increase the design space of the magnetic array in embodiments of the present disclosure.

Magnet array (103) may be a linear array of four distinct attachment magnets. However, more or fewer magnets may be used without departing from the present disclosure. Likewise, the array may have a non-linear layout (for instance, it may be a 2×2 array rather than a 1×4 array). Similarly, the term “array” is not intended to be limited to regularized or uniform layouts; the spacing between attachment magnets may vary and still be considered an “array” within the meaning of the present disclosure. Rather, the term “array” is used more generally herein to refer to the layout of attachment magnets and/or magnet shunt assemblies in a particular application of the instant teachings.

Magnets may take the form of one or more permanent magnets having a thickness of at least about 1/16 inches and having one or more permanent magnetic poles per magnet attachment face. Encapsulation textile (104) may be a second non-elastic woven or non-woven textile coated on at least one side with thermoplastic coating to permit thermal, ultrasonic, radiofrequency, or other plastic bonding of the textile to itself or a similar material, to completely encapsulate each magnet shunt assembly when welded, bonded, or likewise joined to a material of the same type.

Interface material (105) may be a flexible polymer which may be topically applied or impregnated into a textile carrier prior to being secured to the encapsulated magnet shunt assembly or magnet shunt assemblies through sewing, bonding, welding, or another permanent attachment technique. The interface material (105) may be between the encapsulated magnet shunt assembly or multiple distinct assemblies and the external environment or aircraft surface. This may increase the retention of the applicable aircraft equipment to the aircraft when loaded in shear, reduce buffeting and abrasion damage from said equipment sliding or moving during prolonged use, and provide a preliminary seal from foreign object debris (FOD).

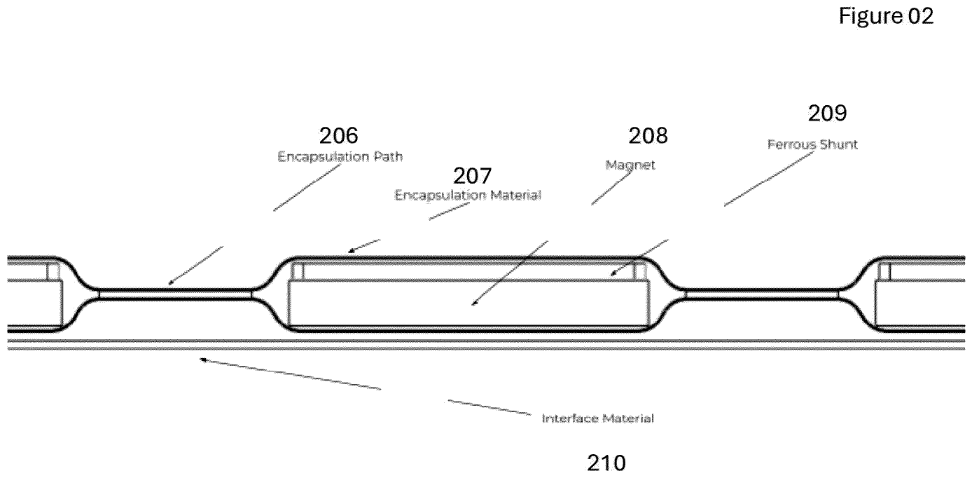

FIG. 02 depicts a section view of encapsulated magnet shunt assembly in a textile according to an embodiment of the present disclosure. As depicted herein, multiple magnet shunt assemblies may be encapsulated within encapsulated textiles (101, 104, FIG. 01). Encapsulation path (206) is depicted in FIG. 02 for encapsulated textiles (101, 104, FIG. 01) through welding, bonding, or another suitable method around the entirety of each distinct magnet shunt assembly. The orientation (207) of encapsulated textile (101, 104, FIG. 1) is depicted with reference to magnet shunt assembly (208, 209). Magnet (208) may be a distinct attachment magnet secured to a distinct ferrous shunt (209) in the assembled state. The location (210) of interface material (105) also is depicted in FIG. 02.

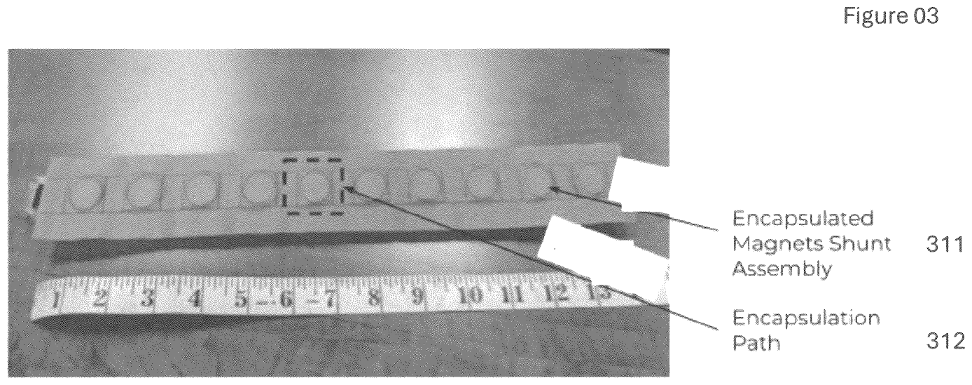

FIG. 03 depicts an encapsulated magnet shunt assembly (311) in a textile according to an embodiment of the present disclosure. As depicted herein, ten distinct magnet shunt assemblies (311) may be arranged in a linear array and encapsulated within encapsulated textiles (101, 104, FIG. 01). However, it should be appreciated that more or fewer magnet shunt assemblies may form a linear or non-linear array without departing from the present disclosure. Encapsulation path (312) around the entirety of one distinct magnet shunt assembly (311) is depicted in FIG. 03 and may be considered an exemplification of the encapsulation path around all magnet shunt assemblies.

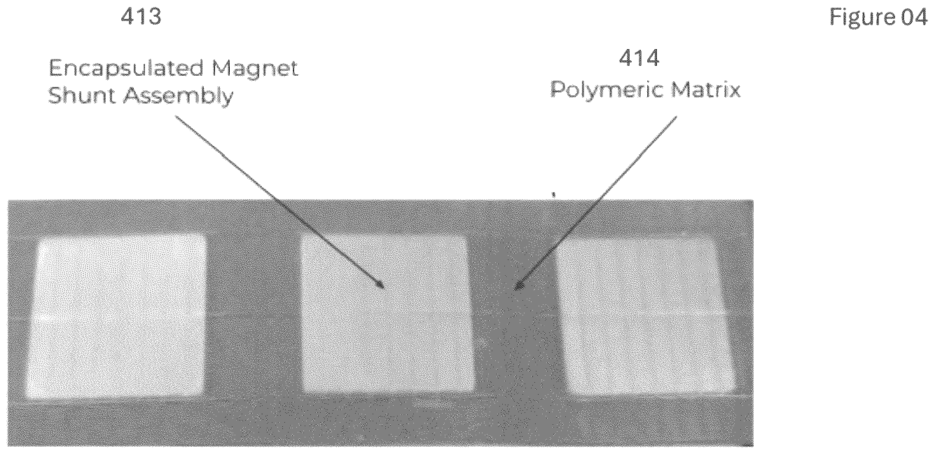

FIG. 04 depicts an encapsulated magnet shunt assembly in a polymeric matrix according to an embodiment of the present disclosure. More specifically, three magnet shunt assemblies (413) may be arranged in a linear array and may be embedded in or fully encapsulated by a polymeric matrix (414) with additional thickness. However, it should be appreciated that more or fewer magnet shunt assemblies may be in a linear or non-linear array without departing from the present disclosure.

Polymeric matrix may be considered the interface material between the magnet shunt assembly and the external environment or aircraft surface. In some cases, or assemblies, it should be appreciated that a polymeric matrix may supplement or entirely replace the encapsulated textiles (101, 104, FIG. 01). Polymeric matrix (414) may be co-molded to the single or arrayed magnet shunt assemblies and may have a thickness of at least about 0.03 inches of interfacial polymer applied to a single or multiple magnet shunt assemblies in excess of the thickness required to imbed or fully encapsulate each distinct magnet shunt assembly in an embodiment of the present disclosure. The flexible polymer may increase the retention of the desired equipment when loaded in shear, reduce buffeting and abrasion damage from equipment sliding or moving during prolonged use, and/or provide a preliminary seal from foreign object debris (FOD). This assembly type may be used in applications which may require an enhanced ability to prevent unwanted fluids from penetrating through the magnetic attachment.

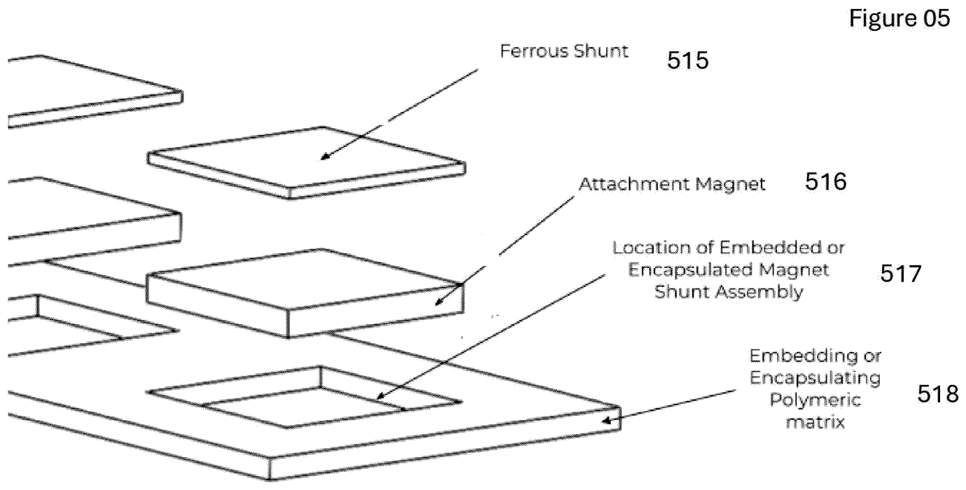

FIG. 05 depicts an exploded view of embedded or encapsulated magnet shunt assembly in a polymeric matrix according to an embodiment of the present disclosure. One or more ferrous shunts (515) may be attached to one or more attachment magnets (516) in a manner to form a magnet shunt assembly arranged in a linear or non-linear array. 517 depicts the negative space or cavity which may be filled by the encapsulated or embedded magnet shunt assembly. Polymeric matrix (518) may be used to embed or encapsulate the magnet shunt assembly with additional thickness to provide an interfacial surface between the magnet shunt assembly and the external environment or aircraft surface in embodiments of the present disclosure. “Interfacial surface” as used herein may refer to the surface(s) which interface, contact, or touch the surface of the aircraft when the covering is installed.

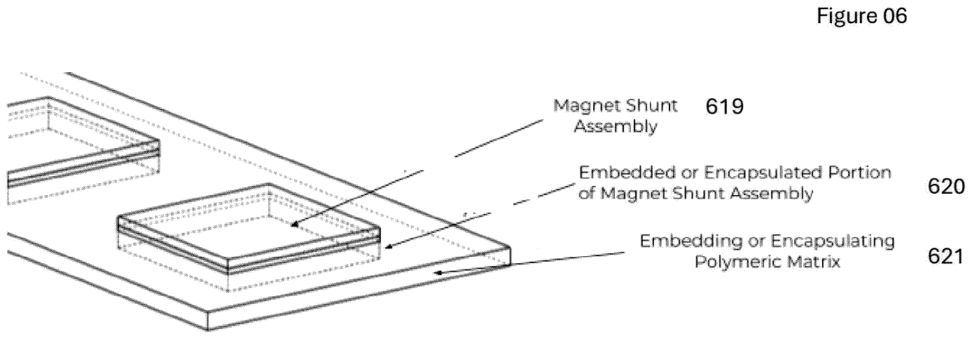

FIG. 06 depicts an embedded or encapsulated magnet shunt assembly in a polymeric matrix according to an embodiment of the present disclosure. As depicted herein, more than one magnet shunt assembly (619) may be arranged in a linear array and embedded in a polymeric matrix (621). Encapsulated or embedded portion (620) depicts a majority portion of the magnet shunt assembly that may be embedded or encapsulated within the polymeric matrix when fully assembled to position, secure, and/or protect the magnet shunt assembly.

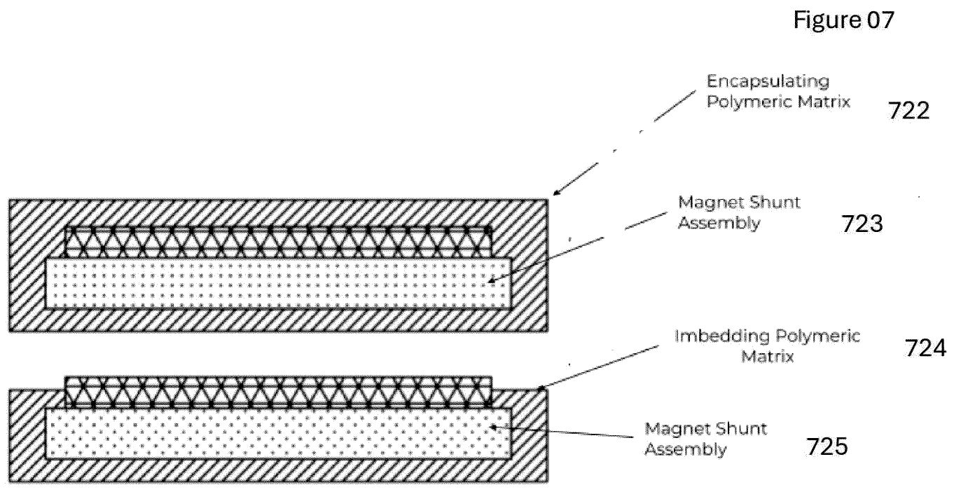

FIG. 07 depicts a section view drawing of encapsulated and embedded magnet shunt assemblies in a polymeric matrix according to an embodiment of the present disclosure. Magnet shunt assemblies (723, 725) may be embedded (724) or encapsulated (722) within a polymeric matrix, to locate, secure, and/or retain the magnet shunt assembly. It should be appreciated that the embedding or encapsulation methodology may vary depending on desired equipment requirements or application in embodiments of the present disclosure.

Embodiments of the present disclosure also may provide protective barrier(s) that can be removably installed for aircraft critical areas. These protective barriers may protect said area(s) from foreign objects during ground-based activities and storage and may be primarily constructed from a polymeric material. Embodiments of the present disclosure may achieve a continuous seal to isolate the critical area when the barrier is (or barriers are) removably installed.

Such barriers may further utilize a magnetic attachment for aircraft equipment according to embodiments of the present disclosure described herein. The magnetic attachment may be arranged in a continuous or semi-continuous perimeter array to remove the need for secondary attachment techniques such as straps, buckles, hooks, cords, ropes, pins, or the like to secure the barrier(s) to the aircraft around the entirety of the covering perimeter.

A barrier according to embodiments of the present disclosure may protect a critical area on the aircraft from foreign objects (e.g., dust, debris, insects, water intrusion, and so on). The barrier may be capable of conforming to or may be conformed to the curvature and geometry of the critical area and/or surrounding surfaces. It may exhibit the ability to withstand repeated exposure to common aviation chemicals or fluids without notable deterioration, the ability to be resistant to fluid penetration, absorption, or transfer through the barrier, and/or the ability to retain its primary characteristics and function from −40° F. up to at least about 120° F. in embodiments of the present disclosure. The barrier may be constructed with a continuous or segmented seal around the perimeter of the barrier which may prevent foreign objects from entering between the barrier and the critical area or aircraft surface. It may be positioned, secured, and/or retained to the aircraft using the magnetic attachment for aircraft equipment as described herein.

While a barrier according to embodiments of the present disclosure may be discussed herein in the context of aircraft equipment, it should once again be appreciated that it may also be applied to ground-based vehicles, both manned and unmanned, including, but not limited to, automobiles, heavy wheeled or tracked vehicles such as tanks, industrial wheeled or tracked vehicles such as excavators, or the like.

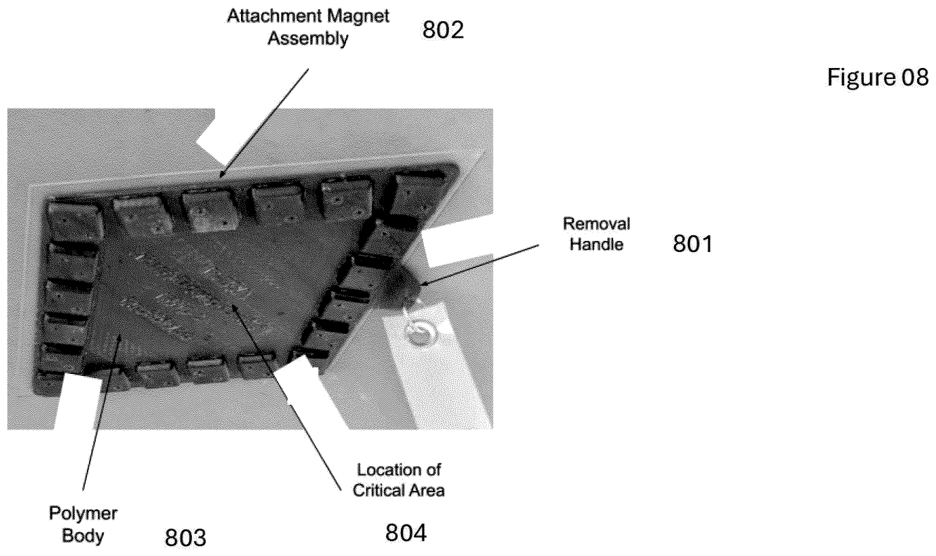

FIG. 08 depicts a protective barrier removably installed on an aircraft critical area according to an embodiment of the present disclosure. The protective barrier may include removal handle (801) which may include a “Remove Before Flight” safety streamer in an embodiment of the present disclosure. Attachment magnet assembly (802), such as previously described in FIGS. 01-07, may be incorporated to remove the need for attachment straps, buckles, hooks, cords, ropes, pins, adhesives, or the like. Polymer body (803) may be inboard attachment magnet assembly (802) and/or sealing gaskets. Critical area (804) may be the location of the underlying critical area when the barrier is properly installed on or attached to the aircraft.

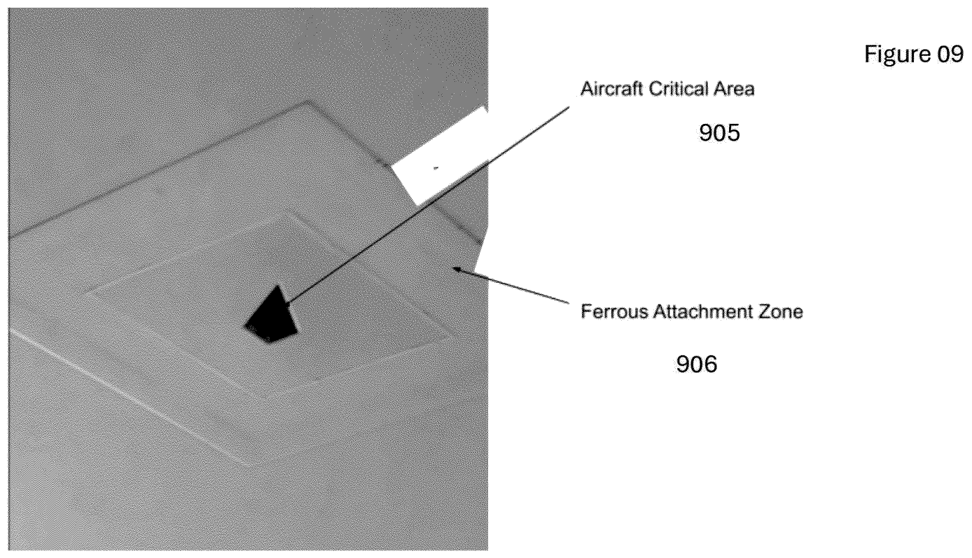

FIG. 09 depicts an example of an aircraft critical area according to an embodiment of the present disclosure. The representative critical area (905) may be an area for which a removal and reusable barrier may be required. Ferrous attachment zone (906) may represent the area for attachment and retention according to embodiments of the present disclosure.

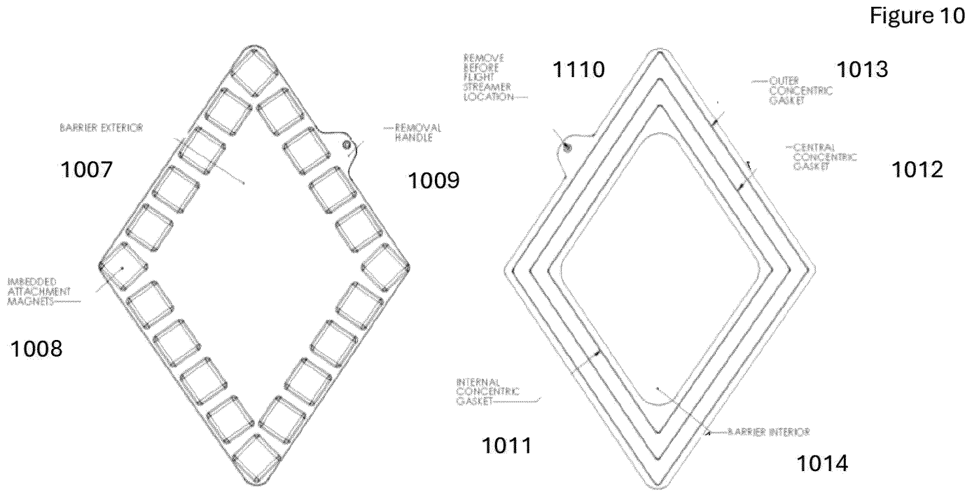

FIG. 10 depicts the interior and exterior surfaces of a representative protective barrier as constructed according to an embodiment of the present disclosure. Exterior surface of the barrier (1007) and interior surface of the barrier (1014) may be provided along with attachment magnets (1008). The protective barrier may also include integrated removal handle (1009) a reinforced hole to removably attach a safety “Remove Before Flight” streamer or the like (1110), an internal concentric gasket (1011), a central concentric gasket (1012), and an outer concentric gasket (1013). While certain placements or locations are identified, it should be appreciated that the placements or locations depicted are merely exemplary and may change in particular applications of the present teachings without departing from the present disclosure.

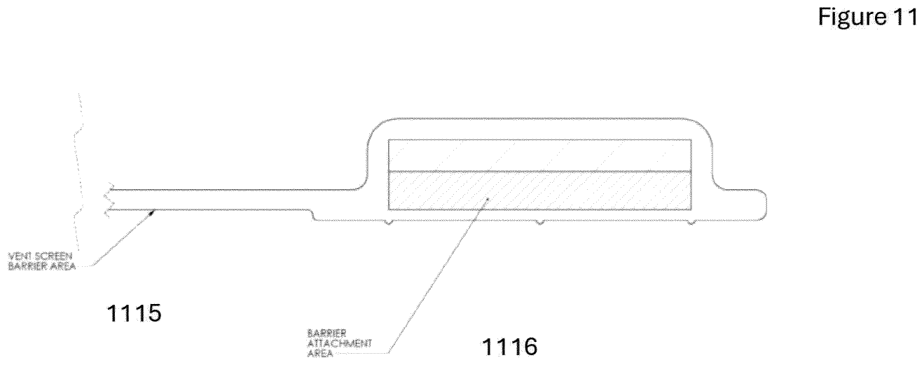

FIG. 11 depicts a section view of a representative protective barrier according to an embodiment of the present disclosure. Vent screen barrier area (1115) may protect the aircraft critical area. Barrier attachment area for attachment magnet (1116) also is depicted herein.

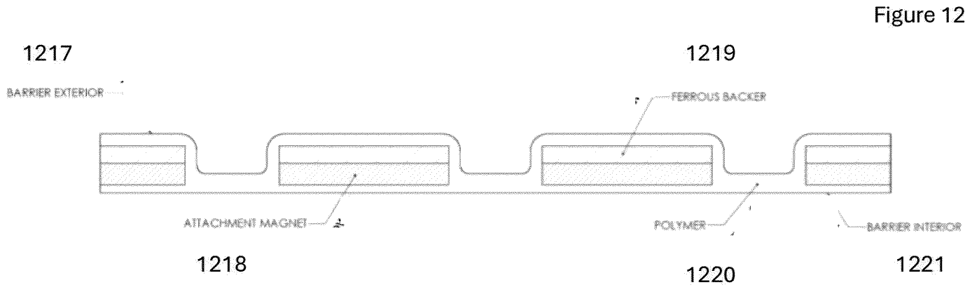

FIG. 12 depicts a section view of a magnetic attachment mechanism as located within the assembly of a protective barrier according to an embodiment of the present disclosure. The exterior of a representative barrier (1217) and interior surface of the barrier (1221) are depicted herein. Locations of magnet shunt pairs (1218, 1219) also are depicted herein. Polymer (1220) may be the primary composition material of the representative barrier in an embodiment of the present disclosure.

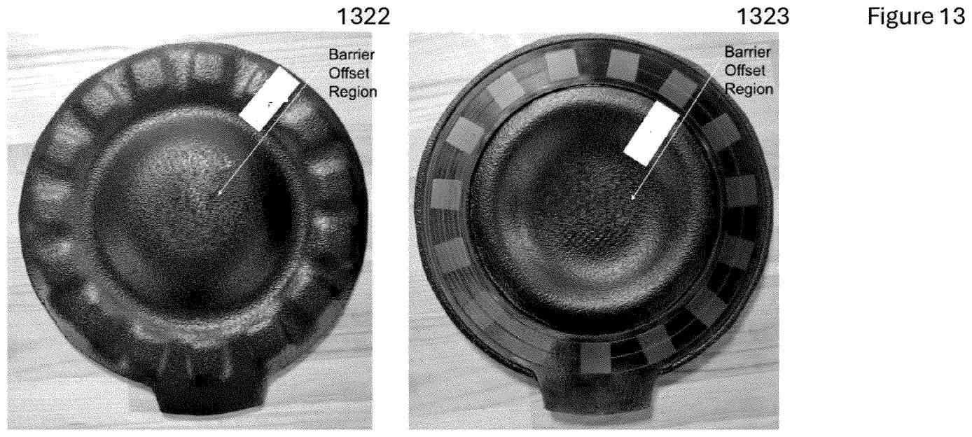

FIG. 13 depicts an example of a protective barrier that may be removably installed on an aircraft critical area and that includes a geometric offset region to accommodate a lens, light, or other transparency according to an embodiment of the present disclosure. There may be a convex offset region (1322) on the exterior surface of such a barrier and a concave offset region (1323) on the interior surface of such a barrier.

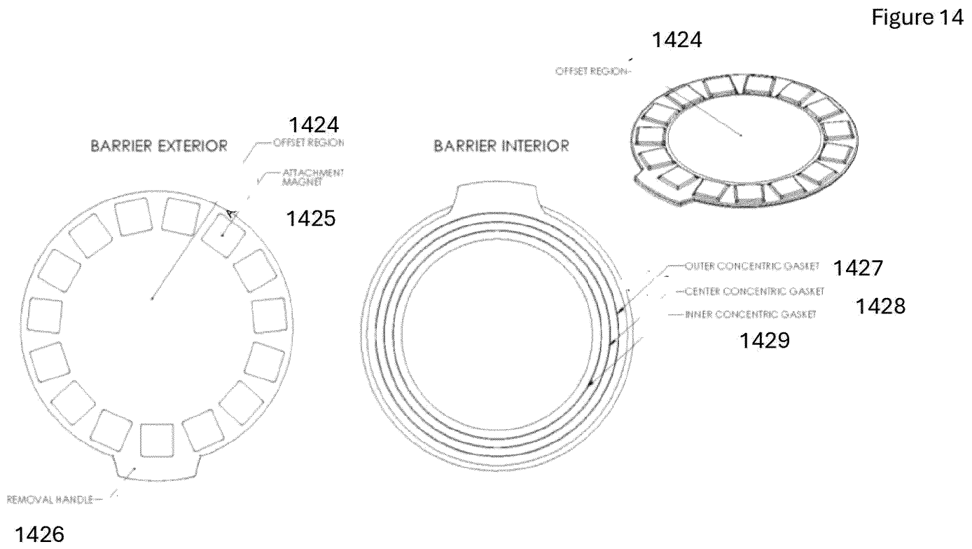

FIG. 14 depicts the interior and exterior surfaces of a representative protective barrier with a physical offset region from a critical lens, sensor, light surface, or other transparency according to an embodiment of the present disclosure. There may be a convex offset region (1424) on the exterior of the barrier and a magnet attachment (1425) as well as a removal handle (1426). Outer concentric gasket (1427) may be located on the internal surface of a barrier, and a center concentric gasket (1428) and an inner concentric gasket (1429) may be located on the internal surface of the barrier as depicted in FIG. 14.

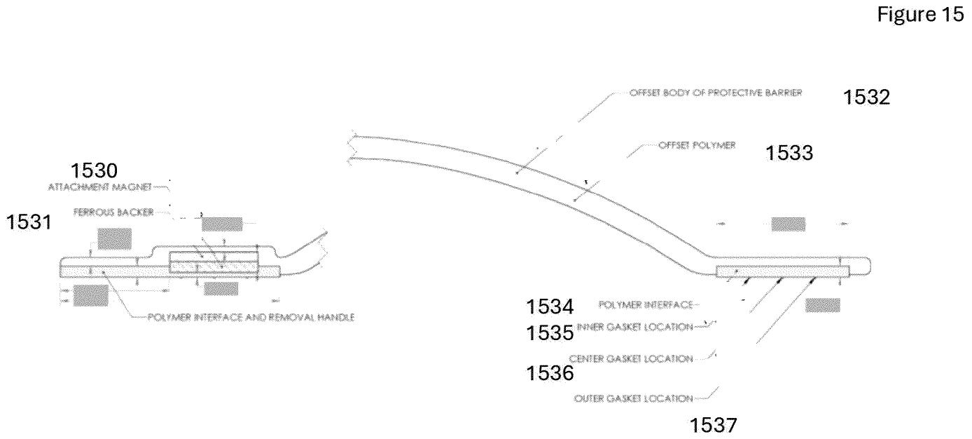

FIG. 15 depicts a section view of a physical offset region from a critical lens, sensor, light surface, and/or transparency according to an embodiment of the present disclosure. There may be a magnet shunt pair (1530, 1531) located approximately where depicted in FIG. 15. There may be an offset region (1532) located inboard of the attachment region of a protective barrier having a material composition (1533). A polymeric interface (1534) may be provided, and the barrier may include inner concentric gasket (1535), center concentric gasket (1536), and outer concentric gasket (1537) approximately located as depicted in FIG. 15.

Embodiments of the present disclosure also may provide a conformable covering for an aircraft transparency which may exhibit the ability to conform to complex (e.g., doubly curved) surfaces through the implementation of elastomeric materials in the covering construction. As used herein, “transparency” may include, but is not limited to, an aircraft windshield, canopy, window, lens, or other component which is constructed of transparent materials. “Conformable” may include, but is not limited to, an ability to mimic, comply, mirror, or adapt to the curvature or geometry of an aircraft transparency. “Cover” or “covering” may include, but is not limited to, one or more materials assembled in such a manner as to create a barrier between the aircraft transparency and the external environment which may be temporarily installed on the external surface or surfaces of a transparency. The covering may utilize a magnetic attachment as described herein arranged in a continuous or semi-continuous perimeter array to remove the need for secondary attachment techniques such as straps, buckles, hooks, cords, ropes, pins, or the like, to secure the covering to the aircraft around the entirety of the covering perimeter. The covering also may include a continuous or substantially continuous seal to isolate the transparency from environmental conditions when the covering is installed. “Seal” may include, but is not limited to, a surface, barrier, material, or the like, which prevents unwanted or undesirable objects, contaminants, or the like from progressing, moving, penetrating, or intruding beyond the seal.

A conformable covering for an aircraft transparency may be capable of conforming to the curvature and geometry of the transparency without the use of darts, folds, or the like in the covering construction. A covering according to embodiments of the present disclosure may be capable of withstanding wind exposure of at least about 50 knots and/or may be capable of being resistant to fluid penetration, absorption, or transfer through the covering. The covering may be capable of retaining its conformable characteristics from at least about −40° F. to about 120° F. It may be constructed with a continuous or segmented seal around the perimeter and/or capable of being positioned, secured, and retained to the aircraft using the magnetic attachment mechanism as described herein.

While conformable coverings according to embodiments of the present disclosure are discussed in the context of aircraft transparencies, those of ordinary skill in the art will appreciate that the teachings herein may be applied to any transparent material that requires a covering, such as but not limited to automobiles windows or windshields, heavy wheeled or tracked vehicle transparency surfaces, surface or submersible vessels such as boats, submarines, or the like, or windows, apertures, or the like integrated into permanent or temporary structures, buildings, or the like.

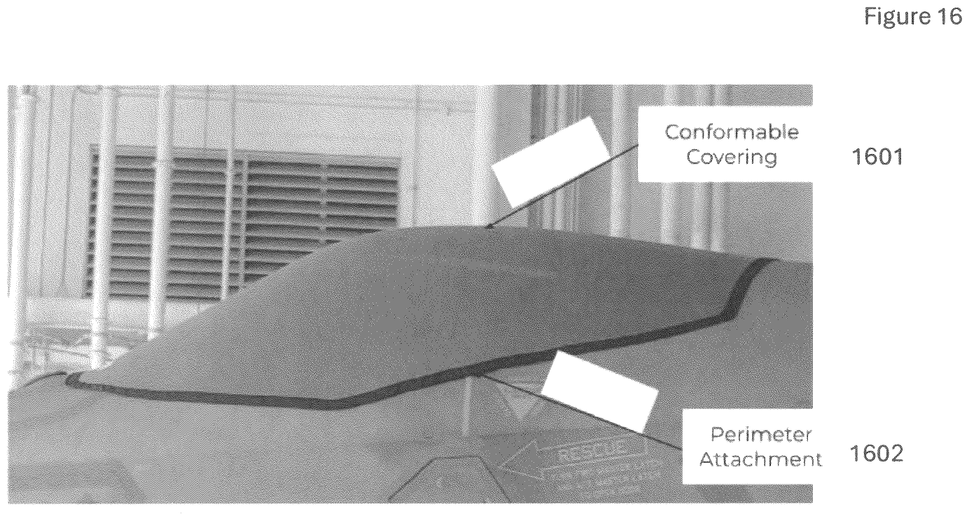

FIG. 16 depicts a conformable covering installed on a representative aircraft transparency according to an embodiment of the present disclosure. Aircraft transparency may be doubly curved as depicted in FIG. 16. Covering may include conformable cover body (1601) which may mimic the doubly curved geometry of the underlying transparency without the use of folds, darts, material bunching, or the like. Attachment magnet subassembly (1602) may be provided to remove the need for attachment straps, buckles, hooks, cords, ropes, pins, or the like.

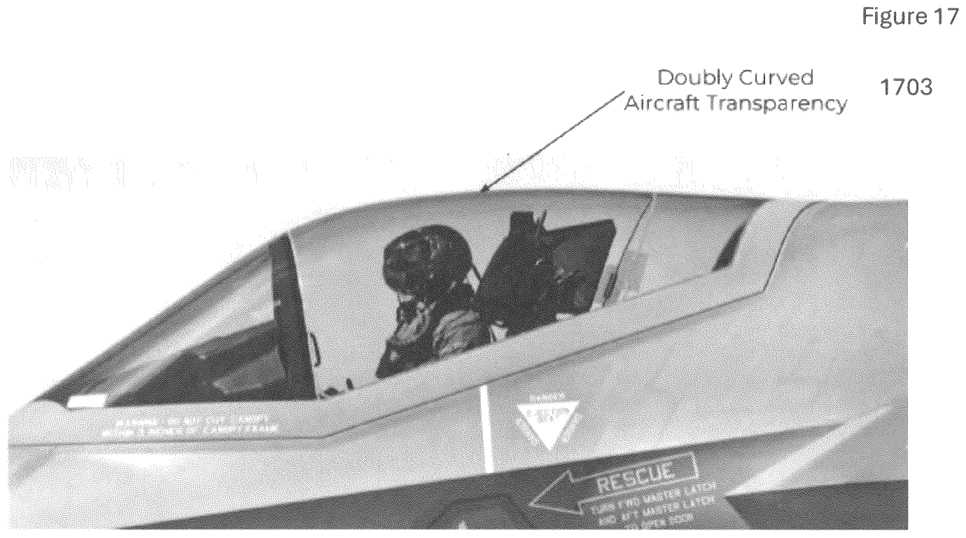

FIG. 17 depicts a representative, uncovered aircraft transparency (1703) demonstrating the doubly curved nature of modern aircraft transparencies, according to an embodiment of the present disclosure.

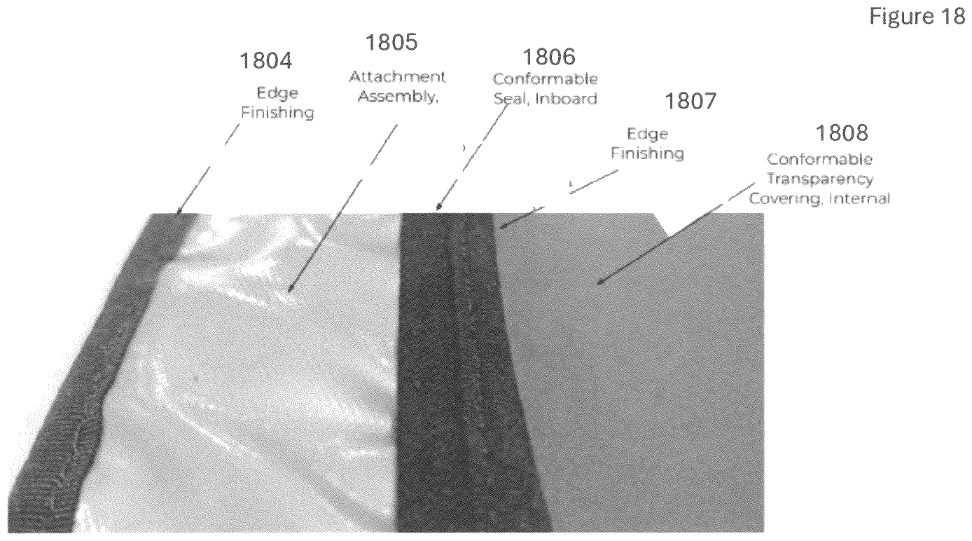

FIG. 18 depicts the conformable covering edge attachment assembly's interfacial surface between the covering and the aircraft according to an embodiment of the present disclosure. The interfacial surface may be between the perimeter attachment mechanism which has been joined to the conformable covering material and the surface of the aircraft. Perimeter edge finishing (1804) may secure and finish the edge of the magnetic attachment subassembly. Magnetic attachment (1805) may be oriented to depict the interfacial surface of the attachment assembly which contacts the surface of the aircraft when correctly installed on the transparency. Continuous or segmented seal (1806) may be located inboard the attachment magnetic array to prevent environmental debris or foreign objects such as sand, dust, water, chemicals, insects, or wind gusts from entering, intruding, or becoming trapped between the installed covering and the aircraft transparency. It also may be oriented to depict the interfacial surface of the magnet shunt pair which contacts the surface of the aircraft when correctly installed on the transparency. Internal edge finishing (1807) may secure and finish the raw edges of the attachment mechanism, seal, and conformable covering. Internal surface (1808) of the covering may be attached to the perimeter attachment magnetic array and sealing mechanism.

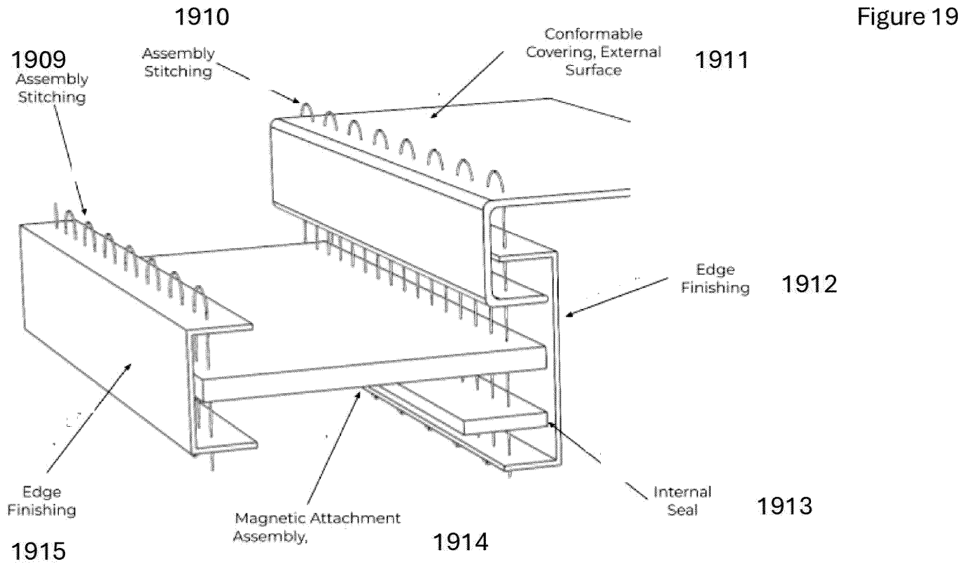

FIG. 19 depicts an exploded drawing of the edge attachment assembly according to an embodiment of the present disclosure. More specifically, FIG. 19 depicts the conformable covering material secured to the perimeter attachment and securing mechanism. Assembly stitching (1909, 1910) may be used to secure the edge finishing to the raw edges of the magnetic attachment array, internal sealing mechanism, and/or conformable covering material. It should be appreciated that assembly stitching may include stitching, serging, or other textile joining techniques. External surface (1911) of the conformable covering may be joined to the perimeter attachment assembly. Edge finishing material (1912, 1915) may capture, secure, and finish the raw edges of the internal edge (1912) and edges (1915) of the magnetic attachment array, the internal seal, and the conformable covering. Seal mechanism (1913) may be located inboard the magnetic attachment mechanism to prevent environmental debris or foreign objects such as sand, dust, water, chemicals, insects, or wind gusts from entering, intruding, or becoming trapped between the installed covering and the aircraft transparency. Magnetic attachment assembly (1914) is depicted as a completed assembly.

As discussed herein, “aircraft” may refer to any manned or unmanned, fixed, rotary-winged, or otherwise powered machine or vehicle which is capable of manned or unmanned flight. “Aircraft” may include but is not limited to fixed wing airplanes, helicopters, or drones. It also may be appreciated that “critical area(s)” may refer to any component, artifact, feature, system, lens, sensor, or the like which is required for safe, proper, or as-intended aircraft operation and flight. “Foreign object” may refer to any chemical, object, or material which is not intended to be located in, on, or near a specific location on or inside the aircraft. “Maintenance” may refer to any ground-based task, action, or procedure required to sustain, repair, service, or inspect an aircraft. “Storage” may refer to an aircraft which is designated to short or long-term holding, placement, or stationing, or which is not in frequent operation. “Reusable” may refer to the ability to be removed after attachment or installation to an aircraft and reattached, or reinstalled, without any degradation or deterioration in its performance.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A magnetic attachment for aircraft equipment comprising:
one or more magnets, wherein each of the one or more magnets includes a magnet attachment face comprising one or more permanent magnetic poles and an opposing face opposite the magnet attachment face;
one or more ferrous shunts, each of the one or more ferrous shunts being secured to a respective opposing face to form a magnet shunt assembly; and
at least one encapsulating mechanism encapsulating each magnet shunt assembly individually,
wherein the magnet shunt assemblies form an array.

2. The magnetic attachment of claim 1, the at least one encapsulating mechanism comprising:
a first textile; and
a second textile, wherein the first textile and the second textile are joinable to each other.

3. The magnetic attachment of claim 2, wherein the first textile and the second textile are non-elastic woven or non-woven textiles.

4. The magnetic attachment of claim 1, the at least one encapsulating mechanism comprising:
a polymeric matrix at least partially encapsulating each individual magnet shunt assembly.

5. The magnetic attachment of claim 1 further comprising:
a non-slip material attached to at least one edge of the at least one encapsulating mechanism to provide an interface between the array and the aircraft.

6. The magnetic attachment of claim 1, wherein each of the one or more magnets has a thickness of at least 1/16″.

7. The magnetic attachment of claim 1, wherein the one or more ferrous shunts are ferrous material having a thickness of at least 20% of the thickness of one of the one or more magnets with perimeter dimensions at least 75% but not more than 125% that of the magnet.

8. The magnetic attachment of claim 1, wherein the one or more ferrous shunts increase an attachment strength of each of the one or more magnets by at least 10%.

9. The magnetic attachment of claim 1, wherein the one or more magnets are four distinct magnets.

10. A removable protective barrier for at least one aircraft critical area, the removable protective barrier comprising:
a polymeric body attachable to the at least one aircraft critical area, the polymeric body capable of conforming to curvature and geometry of the at least one aircraft critical area and surrounding surfaces; and
a magnetic attachment arranged in a perimeter array to secure the polymeric body to an aircraft.

11. The removable protective barrier of claim 10 further comprising:
a seal around a perimeter of the removable protective barrier, the seal capable of isolating the at least one aircraft critical area.

12. The removable protective barrier of claim 11, wherein the seal is secured to the aircraft with the magnetic attachment.

13. The removable protective barrier of claim 10 further comprising:
a removal handle.

14. The removable protective barrier of claim 10 further comprising:
an internal concentric gasket;
a center concentric gasket; and
an outer concentric gasket, wherein each of the internal concentric gasket, the center concentric gasket, and the outer concentric gasket are located on an internal surface of the removable protective barrier.

15. The removable protective barrier of claim 10 having a geometric offset region capable of accommodating a lens, a sensor, a light, and/or another transparency.

16. The removable protective barrier of claim 14, wherein an exterior surface of the removable protective barrier has a convex offset region and the interior surface of the removable protective barrier has a concave offset region.

17. A conformable covering for an aircraft transparency comprising:
one or more elastomeric materials assembled and temporarily installed on at least one external surface of the aircraft transparency to create a barrier between the aircraft transparency and an external environment, wherein the assembly is capable of conforming to doubly curved surfaces; and
a magnetic attachment capable of securing the assembly to an aircraft around an entirety of a covering perimeter.

18. The conformable covering of claim 17, wherein the aircraft transparency is selected from an aircraft windshield, canopy, window, lens, or another aircraft component constructed of transparent materials.

19. The conformable covering of claim 17 further comprising:
a continuous seal capable of isolating the aircraft transparency from environmental conditions when the conformable covering is installed.

20. The conformable covering of claim 17, wherein the magnetic attachment is oriented as to an interfacial surface to contact a surface of the aircraft when installed on the aircraft transparency.
